(19) United States
(12) Patent Application Publication
(10) Pub. No.: US 2026/0058730 A1
(43) Pub. Date: Feb. 26, 2026

(54) IMPLEMENTATION AND ANALYSIS OF 3 DIMENSIONAL SWEEPS FOR IQ MODULATOR CALIBRATION

(71) Applicant: CIENA CORPORATION, Hanover, MD (US)

(72) Inventors: Ying Gao, Kanata (CA); Yves Beaulieu, Nepean (CA); Fan Long, Kanata (CA)

(73) Assignee: CIENA CORPORATION, Hanover, MD (US)

(21) Appl. No.: 18/813,334

(22) Filed: Aug. 23, 2024

(51) Int. Cl. H04B 10/556

(52) U.S. Cl. CPC H04B 10/5561

(57) ABSTRACT

Aspects of the subject disclosure may include, for example, applying a plurality of time-varying bias signals to bias inputs of a quad-parallel Mach-Zehnder (QPMZ) modulator, receiving output signals of the QPMZ modulator, wherein the output signals are produced by the QPMZ modulator responsive to the plurality of time-varying bias signals, and determining a biasing map, optical loss, and optical characteristics including extinction ratio and crosstalk for the QPMZ modulator based on the output signals of the QPMZ modulator. Other embodiments are disclosed.

### FIELD OF THE DISCLOSURE

The subject disclosure relates to a system and method for biasing an in-phase/quadrature (IQ) modulator in a coherent optical modem.

### BACKGROUND

Coherent optical modems may be used for very high data rate data communication, such as 1 Tb/see and above. In a coherent optical modem, transmitter control requires biasing a modulator so that the optical modem transmits a distortion free and correct optical data constellation. This requires selecting correct bias points for the optical modem. With today's fast adaptive network, a speedy, thorough, and accurate way to reconfigure an IQ modulator for obtaining optimum transmitter performance is highly desired. In the meantime, miniaturized high speed modulators have nonlinear phase tuning characteristics and limited phase adjustment range due to the available phase bias tuning mechanism and limited bias electrode size. In this case, the global optimum of bias sets needs to be found accurately in a speedy fashion instead of only a local optimum in a three-dimensional (3D) control space.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of an optical modulation system in accordance with various aspects described herein.

FIG. 2 is a block diagram illustrating an exemplary, non-limiting embodiment of dual polarization IQ modulator structure in accordance with various aspects described herein.

FIG. 3 is a diagram illustrating exemplary, non-limiting embodiment of three-dimensional, digital, digital to analog converter (DAC) output signals in accordance with various aspects described herein.

FIG. 4 is a diagram illustrating exemplary, IQ modulator three-dimensional x-tap samples, in accordance with various aspects described herein.

FIG. 5 is a diagram illustrating exemplary, non-limiting embodiment of IQ modulator mzOut phase variation heat maps for two polarizations, in accordance with various aspects described herein.

FIG. 6 depicts an illustrative embodiment of a method in accordance with various aspects described herein.

### DETAILED DESCRIPTION

The subject disclosure describes, among other things, illustrative embodiments for utilizing and analyzing three-dimensional (3D) sweeps to provide fast and thorough calibration of an IQ modulator's optical characteristics to provide best performance of quadrature amplitude modulation (QAM) using the IQ modulator. Using a sine-wave dither function of a digital bias digital to analog converter (DAC) as the fast sweep, the 3D sweeps of the IQ modulator map out the IQ modulator's various optimum bias points and power capability within a few seconds. Other embodiments are described in the subject disclosure.

One or more aspects of the subject disclosure include applying a plurality of time-varying bias signals to bias inputs of a quad-parallel Mach-Zehnder (QPMZ) modulator, receiving output signals of the QPMZ modulator, wherein the output signals are produced by the QPMZ modulator responsive to the plurality of time-varying bias signals, and determining a biasing map for the QPMZ modulator based on the output signals of the QPMZ modulator.

One or more aspects of the subject disclosure include providing input digital data to a digital to analog converter, receiving, from the digital to analog converter, a dither signal, wherein the dither signal includes a fast signal, a mid signal and a slow signal, applying the fast signal, the mid signal and the slow signal to selected bias inputs of a quad-parallel Mach-Zehnder (QPMZ) modulator, iterating the fast signal, the mid signal and the slow signal among the selected bias inputs of the QPMZ modulator to identify bias values for stable operation of the QPMZ modulator, applying bias signals corresponding to the bias values for stable operation of the QPMZ modulator, and initiating operation of the QPMZ modulator.

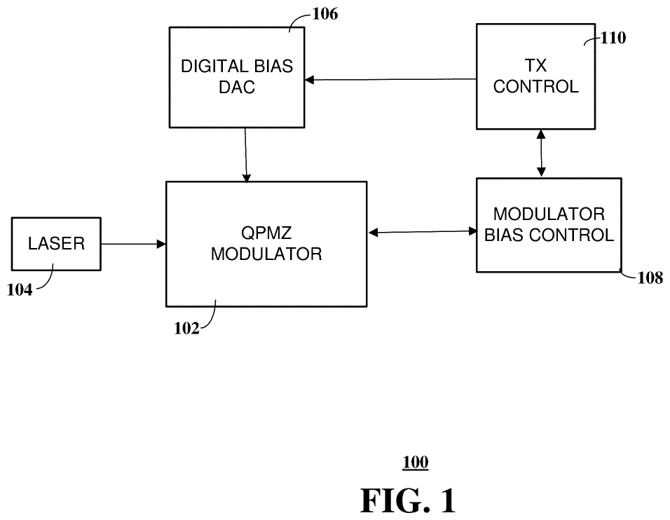

FIG. 1 is a block diagram illustrating an exemplary, non-limiting embodiment of an optical modulation system 100 in accordance with various aspects described herein. The optical modulation system 100 in the example includes a quad-parallel Mach-Zehnder (QPMZ) modulator 102, a laser 104, a digital bias digital-analog converter (DAC) 106, a modulator bias controller 108, and a transmission (TX) controller 110. The laser 104 is optically coupled to the QPMZ modulator 102 to provide a laser output to the QPMZ modulator 102.

The QPMZ modulator 102 operates to modulate the laser output. The QPMZ modulator 102 comprises an optical modulator capable of independently generating orthogonal optical electric field components (in-phase or I channel and quadrature-phase or Q channel). The QPMZ modulator 102 includes Mach-Zehnder (MZ) modulators connected in parallel for producing an output signal.

The digital bias DAC 106 receives a digital command as an input, along with a clock signal, and generates analog signals to bias the QPMZ modulator 102. The digital bias DAC 106 includes a plurality of registers for storing data. A control circuit may write data to the registers. The stored data may correspond to a desired control signal for the QPMZ modulator 102, such as dither clock signal port, dither signal waveform shape, dither amplitude, and center voltage for each channel which is connected to different phase shifter arms of the QPMZ modulator 102. The form of a sine wave can be generated by the digital bias DAC 106. The sine wave takes a step at the raising/falling edge of clock signal at designated ports by register commands.

Analog signals from the digital bias DAC 106 provides MZ phase bias signals for the MZ modulators of the QPMZ modulator 102. Biasing may be required to establish or maintain a stable operating point for each MZ modulator of the QPMZ modulator 102. In embodiments, the QPMZ modulator 102 enables modulation of an X polarization and Y polarization and, for each polarization, there are I and Q channels. Each channel for each polarization may employ an MZ modulator and thus may require biasing via a signal from the digital bias DAC 106. Biasing tracking may further be required to accommodate manufacturing variations in the devices incorporating the QPMZ modulator 102 and to accommodate changing operating conditions such as ambient temperature.

The QPMZ modulator 102 may further include taps or detectors for monitoring output signals of the QPMZ modulator 102. The detected output signals may be provided to the modulator bias control 108.

The Tx controller 110 may operate to control the digital bias DAC 106 and the modulator bias control 108. The Tx controller 110 may implement an optimum bias point selection algorithm. In embodiments, the Tx controller 110 implements an open loop control in which the TX controller 110 controls the digital bias DAC 106 to establish bias points for the QPMZ modulator 102. The Tx controller 110 may further implement a closed loop control in which the modulator bias control 108 monitors QPMZ modulator 102 output signals and applies a feedback control loop to maintain an established set point for biasing. Further, the TX controller 110 may include logic such as a processing system and memory for performing operations including monitoring the QPMZ modulator 102 output signals and controlling or modifying bias signals provided to the QPMZ modulator 102.

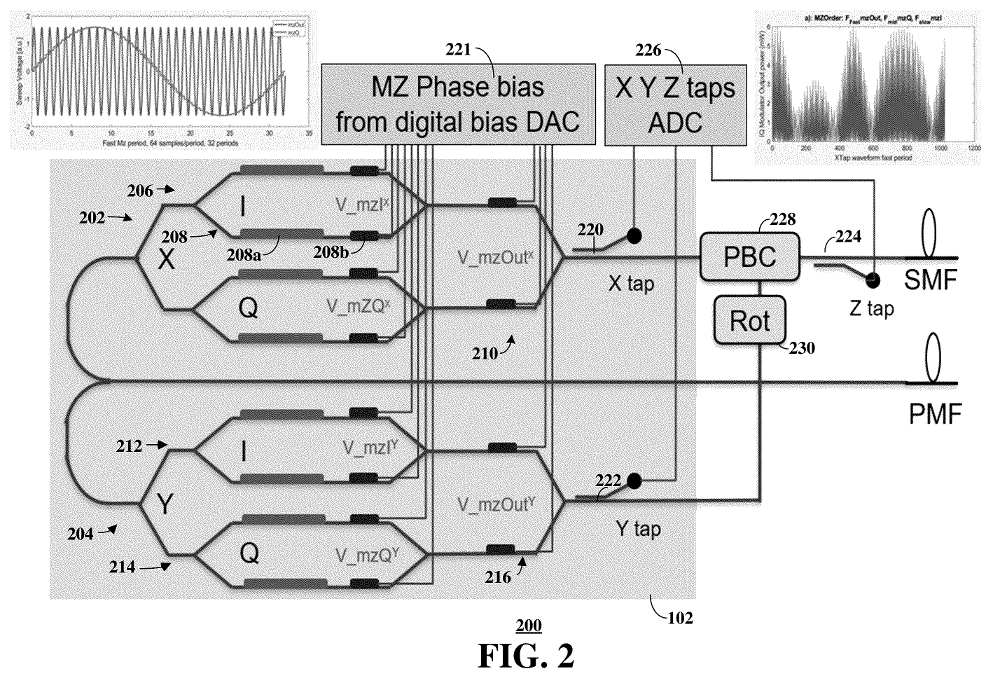

FIG. 2 is a block diagram illustrating an exemplary, non-limiting embodiment of dual polarization IQ modulator structure 200 including the QPMZ modulator 102 of FIG. 1, in accordance with various aspects described herein. In the illustrated embodiment, the QPMZ modulator 102 includes an X modulator 202 and a Y modulator 204, where X and Y denote polarization. The X modulator 202 includes an XI modulator 206, an XQ modulator 208, and an X phase outer modulator 210, where I and Q denote in-phase and quadrature, respectively. Similarly, the Y modulator 204 includes a YI modulator 212, a YQ modulator 214 and a Y phase outer modulator 216. In some embodiments, the QPMZ modulator 102 may include other features or be arranged differently to provide similar functionality.

In embodiments, each modulator of the QPMZ modulator 102 is a Mach-Zehnder (MZ) modulator. The XI modulator 206, the XQ modulator 208, the YI modulator 212 and the YQ modulator 214 may be termed inner modulators. The X phase outer modulator 210 and the Y phase outer modulator 216 may be termed outer modulators compared to the XI and XQ modulators which may be termed inner modulators.

In the exemplary embodiment, the inner modulators include two phase shifter segments. Using XQ modulator 208 as an example, the XQ modulator 208 includes a first phase shifter segment 208a and a second phase shifter segment 208b. The first phase shifter segment 208a are high-speed phase shifters and are associated with a very high data rate. The high-speed phase shifters like first phase shifter segment 208a are used for passing data when the QPMZ modulator 102 is in operation. The second phase shifter segment 208b are used for biasing the inner modulator, XQ modulator 208 in this case. Bias signals may be applied to the inner modulator. Such bias signals are indicated in the drawing figure as V_mzI^{x}, V_mzQ^{x}, V_mzI^{y}, and V_mzQ^{y}. Similarly, the outer modulators, X phase outer modulator 210 and the Y phase outer modulator 216, are biased with vias signals V_mzOut^{x} and V_mzOut^{y}.

As noted, such MZ modulators require global optimum biasing for reliable operation. Accordingly, the polarization IQ modulator structure 200 includes MZ phase biasing 221 which responds to biasing signals received from the digital bias DAC 106 (FIG. 1). Further, the QPMZ modulator 102 in the illustrated embodiment includes an X tap 220, a Y tap 222, a Z tap 224. Each of these taps is configured to sample energy or information from a respective point in the QPMZ modulator 102. Each of these taps is in data communication with an X, Y, Z taps analog to digital converter 226. Information from the taps is converted to digital data for communication to and analysis by other components such as modulator bias control 108 and Tx control 110 (FIG. 1).

Rounding out identification of elements of FIG. 2, the QPMZ modulator 102 includes a polarization beam combiner (PBC) 228 and a polarization rotator 230. The output of the polarization beam combiner 228 provides a combined output of the X modulator 202 and the Y modulator 204 which forms the output of the QPMZ modulator 102.

With the explosion of digital data, current and future coherent modems provide beyond 1 Tbit/s data rates per wavelength. To enable current transmission rate on the modulator side, photonic integrated circuits (PIC) on multiple platforms have been adopted. Integrated high-speed modulators such as the QPMZ modulator 102 utilize new electro-optical materials and compact radio frequency (RF) lines to enhance the electro-optic interaction and reduce RF loss simultaneously. Compared to traditional bulk lithium niobate (LiNbO₃), integrated Indium phosphide (InP), silicon photonics (Siphot), thin-film lithium niobate (TFLN) and other on chip modulation technologies largely reduce the modulator footprint and power consumption, while providing ground-breaking modulation speed and linear high-speed modulation. With vast adaptation of the PIC based high speed modulators, and the flexibility requirement of the adaptive network, a fast, thorough, and accurate way to reconfigure the IQ modulator, such as the dual polarization IQ modulator structure 200, for obtaining optimum transmitter performance is highly desired.

The dual polarization IQ modulator structure 200, including the QPMZ modulator 102 and its supporting biasing circuit, are shown in FIG. 2. To provide the best Quadrature amplitude modulation (QAM) constellation in a coherent transmitter incorporating the dual polarization IQ modulator structure 200, the IQ modulator must be biased at the correct operational point, a static, DC operational point referred to as Min/Min/Quad bias points. I and Q data may then be chirp-less and orthogonal to each other, where chirp relates to the modulator's output frequency modulation and phase modulation. Further, the RF driving level must be large enough to achieve a high signal to noise ratio (SNR) without inducing significant nonlinear distortion. Finally, the RF transfer function of the inner Mach-Zehnder (MZ) modulators must be calibrated, while the calibrating tributary is biased at Quad.

All bias points and optical power capability are found by moving the DC biasing phase-shifters. Unlike phase shifters in bulk LiNbO₃ modulators, the response speed, linearity, and available phase range of the PIC-based phase shifters are limited by the available technology and mask size. For LiNbO₃ modulators, a differential drive phase shifter based on a linear Pockels effect provided very large phase range and multiple local optimums for operational points. The vast DC phase range of the bulk LiNbO₃ modulators also makes it easier and flexible to converge on a few operational points, since more than one set of working points found by local optimization provide good QAM performance and enough bias drift margin in the transmitter.

In integrated high-speed modulators, it is important to identify and use the operational point closest to the middle of the biasing range, which would be the global optimum. Only one set of operational biases at global optimum can enable enough aging drift margin, optimum transmitter performance. Other, local-optimal biases available in the biasing range may not provide the same reliable performance over operating conditions, during an operational period and over the functional lifetime of the device. It should be noted that, as used herein, the term “optimum” need not be limited to a specific value or a specific set of values. For example, a global optimum for operational biases may include a narrow range of bias values that achieve suitable and reliable performance of a modulator.

In some conventional systems, a small dither signal was added to a large DC bias signal. The dither amplitude is controlled to be never more than ten percent of the value of Vx. This may be referred to as a one-dimensional or 1D sweep in which one modulator at a time is swept using a kHz-MHz range dither wave on top of a DC biasing signals. Three separate sweeps are required for each polarization. A DC bias may be applied to a signal MZ inside the IQ modulator, and a one-dimensional sweep is applied. This requires a series of sweeps of the AC dither signal to determine the proper bias point to null all un-swept MZ structures inside the IQ modulator. This will take a substantial amount of time. Moreover, crosstalk from sweeping MZ to nulling MZ inside the device would affect the reliability of measurements.

Accordingly, in accordance with various aspects described herein, a single three-dimensional sweep may be performed to capture all measurements of interest in the 3D sweep. In the 3D sweep operation, all biases are swept simultaneously but at different speeds. For example, the I modulators may be swept at one speed which is 100 times faster than the speed at which the Q modulators are swept, and in turn 100 times faster than the outer MZ modulators are swept. In this manner, while sweeping the I modulators, the Q and outer modulators do not have to move because of the difference in speed of sweeping. This reduces the amount of time for biasing and sweeping to identify the correct bias points. Instead, the effort to identify the correct bias points is pushed to post-processing of measured data. However, that takes relatively little time and greatly improves efficiency.

Further, embodiments of the illustrated process relate to calibration of the QPMZ modulator 102. In general, the calibration process is part of a startup routine when a device incorporating the modulator is powered on. Such a device may include, for example, an optical transceiver, an optical switch or an optical router. In such a device, the required biases may vary with factors such as temperature, wavelength, and time. Variation over time, while the device is operating may be accommodated by closed loop feedback to maintain a stable operating point. However, the device must be calibrated during every startup sequence. Since the illustrated device comprises a coherent transmitter, with both I and Q paths, calibration must provide stable bias locations which supports chirp less amplitude modulation for I and Q and also maintain a 90-degree angle between the in-phase and out of phase information.

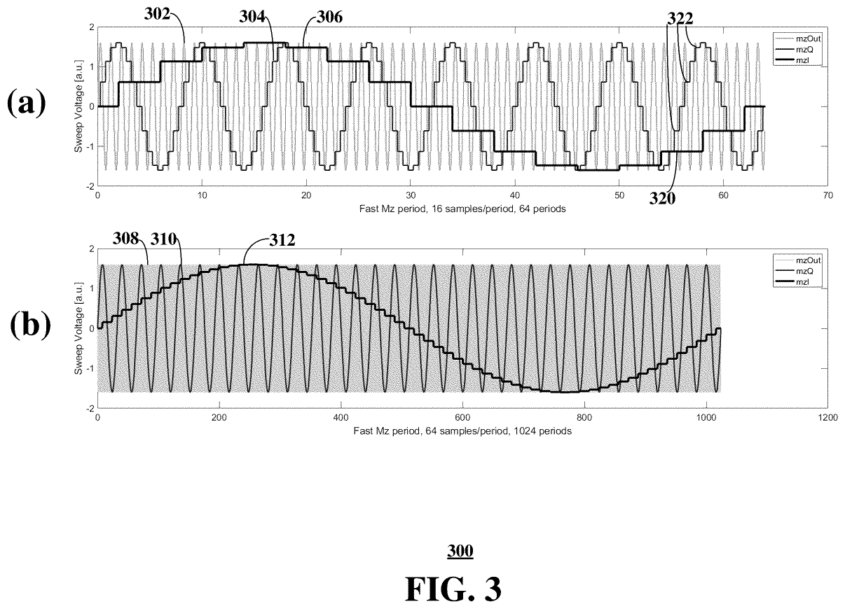

FIG. 3 is a diagram illustrating an exemplary, non-limiting embodiment of three-dimensional, digital DAC output signals 300 in accordance with various aspects described herein. In the example, the digital DAC output signals 300 include a fast signal, a mid signal and a slow signal, where fast, mid and slow describe the relative frequencies of the three signals.

The exemplary embodiments show a 3D sweeping of a full IQ modulator such as QPMZ modulator 102 (FIG. 2). In the example, 3D or three-dimensional sweeping indicates that all input signals are swept across an operating range simultaneously, rather than relying on many specific one dimensional (1D) sweeps on a given MZ modulator. In conventional 1D sweeping to calibrate an QPMZ modulator, one or more of the constituent MZ modulators may need to be isolated or selected taps may need to be used in order to sample internal output signals. The respective MZ branch may interfere with the others during biasing.

During the 3D sweeping in accordance with the illustrated embodiments, there is no need to use designated I/Q modulator taps or to block or isolate any un-swept MZ modulators. All data may be collected at the combined optical output of the IQ modulator and post-processed to find the modulator's best operational condition. In this way, the tap monitor output is most representative of the high-speed data transmission path and the full three MZ modulators' interactions within the nested structure are included. To overcome a phase shifter bandwidth limitation, sine wave sweeping may be used on the fast-sweeping MZ.

FIG. 3(a) illustrates a fast signal 302 having 16 samples per sine period, where each of the 16 steps will be triggered by a control clock. The fast signal 302 may have a frequency given by F_{fast}. Further, FIG. 3(a) shows a mid signal 304. The mid signal 304 has a frequency F_{mid}. Still further, FIG. 3(a) shows a slow signal 306 . . . . The slow signal 306 has a frequency F_{slow}. Referring to the example embodiment of FIG. 2, the fast signal 302 may be applied to the X phase outer modulator 210 and the Y phase outer modulator 216, which may be termed outer modulators. As indicated in FIG. 3, the fast signal 306 is swept at bias points V_mzOut^{X} and V_mzout^{Y}. The mid signal 304 is swept at bias points V_mzQ^{X} and V_mzQ^{Y}. The slow signal 302 may be swept at bias points V_mzI^{X} and V_mzI^{Y}.

Similarly, FIG. 3(b) illustrates a fast signal 308 having 64 samples per period, for 1024 periods. In FIG. 3(b), the fast signal has too high a frequency to resolve each waveform in the drawing figure. Further, FIG. 3(b) shows a mid signal 310. The mid signal 310 has a frequency F_{mid}. Still further, FIG. 3(a) shows a slow signal 312. The slow signal 312 has a frequency F_{slow}. In the example embodiment of FIG. 2, the fast signal 308 may be applied to the X phase outer modulator 210 and the Y phase outer modulator 216, which may be termed outer modulators. As indicated in FIG. 3, the fast signal 308 is swept at bias points V_mzOut^{X} and V_mzout^{Y}. The mid signal 310 is swept at bias points V_mzQ^{X} and V_mzQ^{Y}. The fast signal 312 may be swept at bias points V_mzI^{X} and V_mzI^{Y}.

One example of the 3D waveform is shown in FIG. 3 with two different granularities. A first granularity is shown in FIG. 3(a) and a second granularity is shown in FIG. 3(b). To cover all possible modulator bias combinations of Min/Max/Quad+/Quad−, the sweeping Vpp for any MZ modulator of the QPMZ modulator 102 (FIG. 2) must be larger than 2Vπ where Vπ is the half-wave voltage of the modulator. Vπ is a function of several factors including the materials used to manufacture the MZ modulator. The voltage Vπ corresponds to the applied bias voltage at which the phase difference between light beams on different MZ arms become π. In the illustrated example, Vpp was set to 3.2Vπ. Compared to conventional devices, this Vpp for the dither signal is very large in magnitude. For a granularity of N samples/period for the sine wave, N/2 unique sweeping levels are provided, and each value was measured twice during the sine sweep. The frequencies added on the 3 different MZs are: F_{fast}, F_{mid}=2*F_{fast}/N, and F_{slow}=2*F_{mid}/N=F_{fast}/(N/2)². Each of the fast signal 302, the mid signal 304 and the slow signal is triggered with a clock signal at corresponding stepping speed. The result is not a smooth sine wave but has a number of levels. The levels overlap based on the relative frequencies of the signals. Thus, in FIG. 3(a), for each respective level of the slow signal 306 (corresponding to the I modulator), the mid signal 304 (corresponding to the Q modulator) has levels that traverse the full voltage swing of the mid signal, from top to bottom and bottom to top. The mid signal 304 traverses all of its discrete positions. Thus, for example during the duration when the slow signal 306 is at a level 320, the mid signal 304 passes through levels 322. The same relationship applies to the mid signal 304 and the fast signal 302. For each step of the mid signal 304, the fast signal traverses from min to max or max to min values. As the three signals are varied in this manner, all possible discretized values are applied to the QPMZ modulator 102 to test the full bias mapping.

In embodiments, a sine wave such as fast signal 302 is used to sweep the IQ modulator's low speed phase adjuster, such as second phase shifter segment 208b in FIG. 2. As noted, the high-speed phase adjuster, such as first phase shifter segment 208a, has a very high bandwidth and operate very fast for processing high speed data during operation. However, the second phase shifter segment 208b is slower but provides a larger tuning range. To pass the AC biasing signal, a sine wave is used and applied to the low-speed phase adjuster, the second phase shifter segment 208b. The sine wave includes no higher frequency harmonics or other information and is therefore ideal to sweep the IQ modulator's low speed phase adjuster.

The optical power from the IQ modulator per polarization is a function of the bias at I, bias at Q and bias at the outer modulator. The example of FIG. 3(a) may be considered to be slowed down to illustrate the relationship between the bias signals. The example of FIG. 3(b) may be a more realistic representation of the bias signals is actual applications. However, any suitable bias signals, and relation among the bias signals, may be used. Thus, in FIG. 3(b), the voltages or signals do not appear to be discretized (as they do in FIG. 3(a)). Rather, the signals in FIG. 3(b) flow smoothly through their respective signal ranges.

In total, (N/2)² periods are needed to map out the full IQ modulator map, where the slowest modulator finishes a full cycle. If F_{fast} is the frequency of the fast-sweeping sine wave, the total 3D sweeping time would be:

$$Total sweep time ( {T}_{total} ) = total periods * time per fast period = {( N / 2 )}^{2} / {F}_{fast} . \qquad Eq . 1$$

For a sine wave period (N) of 16 or 64, the granularities are 8 or 32 unique sweeping levels, the total periods are 64 or 1024 respectively. In an example embodiment, the fast sweep sine wave has a frequency of 1 kHz. This value is well within the bandwidth of most heater or diode-based phase-shifters. In that example, the total required sweeping time would be 1/1 kHz*1024=1.024 seconds per polarity, for each of the X polarity and the Y polarity.

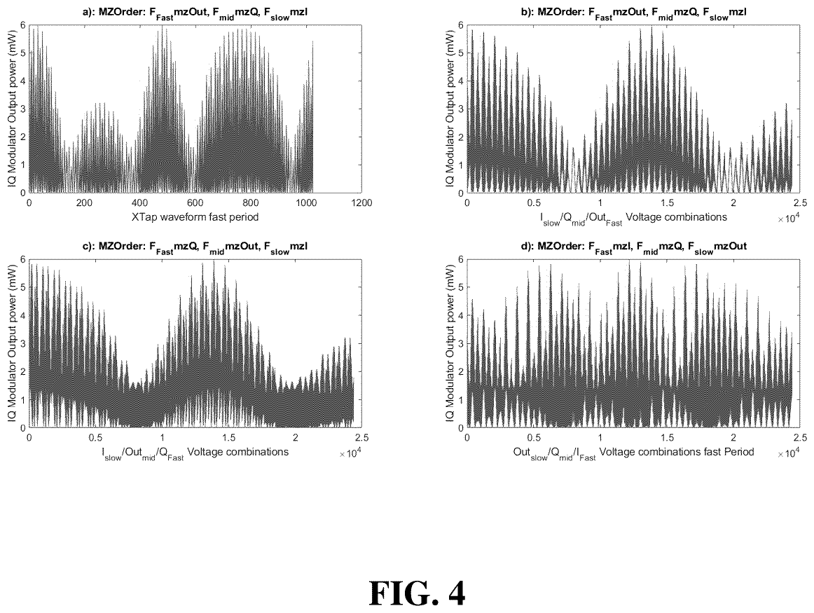

FIG. 4 is a diagram illustrating exemplary, IQ modulator three-dimensional x-tap samples, in accordance with various aspects described herein. FIG. 4 shows examples of captured waveforms using 1 kHz fast frequency and N=64. In FIG. 4(a), IQ modulator output power (Y axis) is shown for fast period signals received at the x tap 220 and captured by Xtap ADC channel 226 (FIG. 2) in the order or receiving time. In FIG. 4(a) F_{fast} is applied to MzOut, F_{mid} is applied to MzQ and F_{slow} is applied to mzI as the bias points indicated in FIG. 2. After digitization at the MZ bias DAC 221 (FIG. 2), the voltage levels applied on each MZ were 29 levels instead of N/2=32, since a few levels are very close and combined into one level after quantization.

FIG. 4 (b-d) gives 3 different examples where the fast/mid/slow sweeping MZs are different. The 3D algorithm does not require the fast-sweeping signal on any of the MZ structures in the IQ modulator if the 3 sub MZs are swept in different frequencies of the 3D sweep. FIG. 4(b) shows modulator output power (Y axis) for 3D ADC samples in the order of I-Q-Outer voltages, at the ADC 226 (FIG. 2). Here, F_{fast} is applied to MzOut, F_{mid} is applied to MzQ and F_{slow} is applied to mzI at the bias points indicated in FIG. 2. The tap ADC sample with time as shown in FIG. 4(a) were re-ordered in Slow/Mid/Fast voltage combinations. The total voltage combinations are 29*29*29=24,389 in this example as shown on the x axis of FIG. 4(b). FIG. 4(c) shows IQ modulator output power (y axis) versus 3D voltages in the order of I-Out-Q combinations at the ADC 226. Here, F_{fast} is applied to MzQ, F_{mid} is applied to MzOut and F_{slow} is applied to mzI at the bias points indicated in FIG. 2. FIG. 4(d) shows IQ modulator output power (y axis) for 3D voltages in the order of Out-Q-I combinations at the ADC 226. Here, F_{fast} is applied to MzI, F_{mid} is applied to MzQ and F_{slow} is applied to mzOut at the bias points indicated in FIG. 2.

If the phase-shifter bandwidth is much larger than 1 kHz, increasing the sweeping frequency would also reduce the total required sweeping time proportionally. Since X tap 220 only have information on x polarization of the QPMZ 202 and Y tap 222 only have information on the y polarization of the QPMZ 204, if X and Y tap information were captured at the same time, the 2 independent 3D sweeps could be performed on x and y polarization simultaneously. If the Z tap 224 were used to capture the QPMZ information about both x and y polarization, the 2 independent 3D sweeps would need to be performed sequentially. Analytically, the IQ modulator's response is expressed as a mathematical function on each of the 3 monitoring taps:

$$Ptap\_x = IQfunx ( {V}_{m z I x} , {V}_{m z Q x} , {V}_{m z O u t x} ) , Ptap\_y = IQfuny ( {V}_{m z I y} , {V}_{m z Q y} , {V}_{m z O u t y} ) , Ptap\_z = IQfunz ( {V}_{m z I x y} , {V}_{m z Q x y} , {V}_{m z O u t x y} ) \qquad Eq . 2$$

During the implementation example of FIG. 4, the 32 sine wave levels were quantized to 29 levels, with some very closed levels combined. For each unique V_{mzI}, V_{mzQ}, V_{mzOut} set, at least two ADC values were measured, where an average was taken to get the Ptap (x,y,z), which is shown in the examples of FIG. 4(b), FIG. 4(c) and FIG. 4(d). In these three examples V_{mzOut} may be designated as the fast frequency (FIG. 4(b)), mid frequency (FIG. 4(c)) or slow frequency (FIG. 4(d)) during the sweep.

The model of Eq. 2 may be used for post-processing the received ADC signal from any of X/Y/Z taps 226 as a function of 3D sweeping signal generated by phase bias DAC 221 to bias each polarization of the QPMZ modulator 102. From this 3D power mapping function, the control efficiency of each voltage (1st harmonic) may be calculated for each input. Further, the second harmonic and the beat frequency will also be calculated.

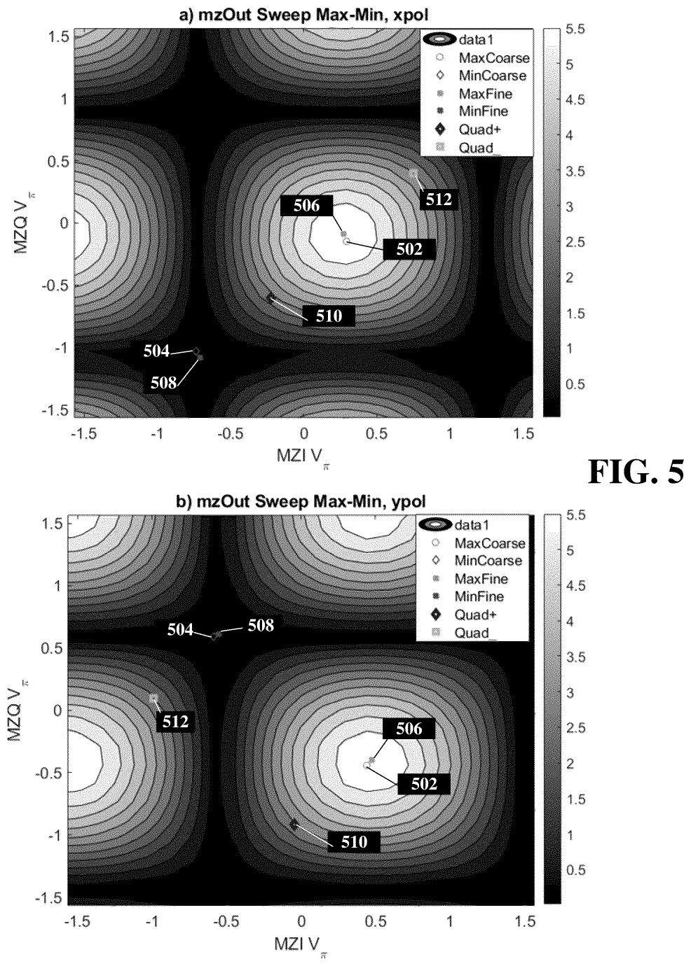

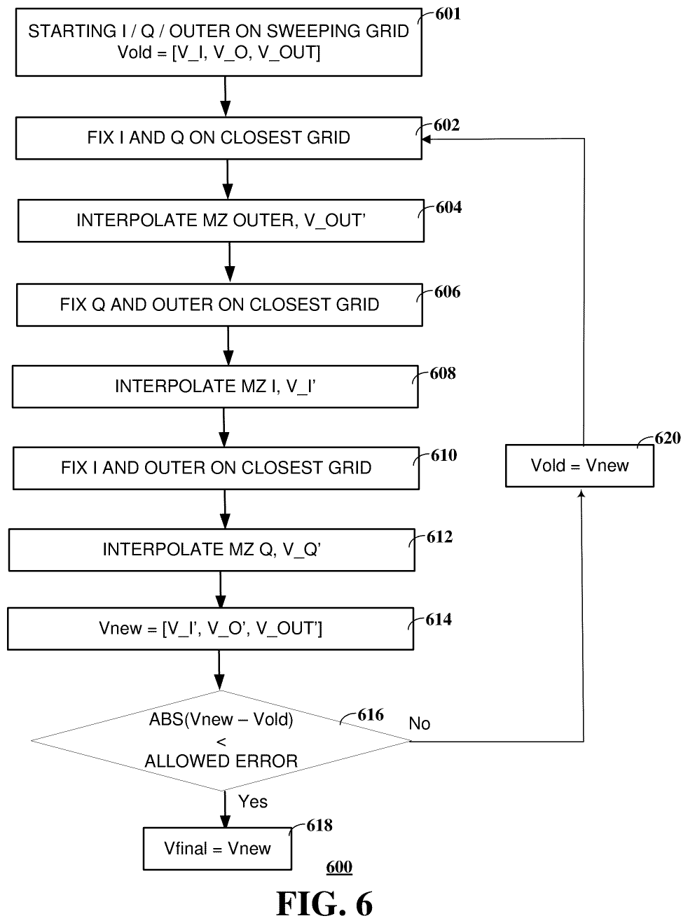

FIG. 5 is a diagram illustrating exemplary, non-limiting embodiment of IQ modulator mzOut variation heat maps for two polarizations, in accordance with various aspects described herein. FIG. 5(a) depicts X tap 220 or Z tap 224 power variation during mzOut sweep for x polarization, with V_mzQ^{X} shown on the y axis in the unit of V_{π} and applied to an Q modulator such as XQ modulator 208 (FIG. 2) and V_mzI^{X} shown on the x axis in the unit of Vx and applied to an I modulator such as XI modulator 206 (FIG. 2). Similarly, FIG. 5(b) depicts Y tap 222 or Z tap 224 power variation during mzOut sweep for y polarization, with V_mzQ^{Y} shown on the y axis and applied to an Q modulator such as YQ modulator 214 (FIG. 2) and V_mzI^{Y} shown on the x axis and applied to an I modulator such as YI modulator 212 (FIG. 2). FIG. 5(a) and FIG. 5(b) include calculated values labelled MaxCoarse 502, MinCoarse 504, MaxFine 506, MinFine 508, Quad+ 510 and Quad_512. MaxCoarse 502 and MinCoarse 504 correspond to values located on the computational grid used to evaluate the data. The values for MaxFine 506 and MinFine 508 correspond more closely to actual measured values but are not located on the sweeping grid. Starting from the MaxCoarse 502 and MinCoarse 504 values using the algorithm, the MaxFine 506 and MinFine 508 values may be determined by post processing the captured data as shown in FIG. 6. Note that the maximum and minimum coarse and fine values occur near the center of the bright portion and the dark portion of the heat map, respectively. Among a few possibilities the set of Max/Min closest to the 0 value on the x-axis and the y-axis were chosen with the sweep. Quadrature values Quad+ 510 and Quad− 512 may also be determined. If the value corresponds to a rising edge, from minimum to maximum, it is termed Quad+. If the value corresponds to a falling edge, from maximum to minimum, then it is termed Quad−. The points illustrated in FIG. 5(a) and FIG. 5(b) will generally repeat with a period of 2Vπ. The target is to always find the operating points close to 0 on all axes.

As a first step of 3D data analysis, for each given pair of V_mzI and V_mzQ the value

$${P}_{t a p O u t V a r} = {P}_{tapOutMa x} - {P}_{t a p O utMi n} \qquad Eq . 3$$

for mzOut sweep may be calculated and shown in FIG. 5 for x polarization (FIG. 5(a)) and y polarization (FIG. 5(b)), where P_{tapOutMax} is the maximum tap power output during outer MZ sweep and P_{tapOutMin} is the minimum tap power output during outer MZ sweep for a given I/Q bias pair. P_{tapOutVar} is minimal when either mzI or mzQ are biased at minimum value. And P_{tapOutVar} is maximum only when both mzI and mzQ are biased at maximum value. The bias voltages mzI and mzQ are applied to the XI modulator 206 and the XQ modulator 208, respectively for the x polarization in FIG. 5(a). MaxCoarse and MinCoarse were found on the 3D sweeping grid, where they are close to the true min and max but still have stepping error from the sweeps. The needed bias combinations to reach max and min are very different for each of the inner MZ modulators, and the global optimum could be anywhere between-Vx to +Vx.

In order to remove the granularity generated biasing map error, further interpolation is needed. Interpolation were based on derivatives of the modulator's response function Ptap were calculated as:

$$\begin{matrix}{1}^{st} harmonic \frac{\partial {P}_{t a p}}{\partial {V}_{m z I}} , \frac{\partial {P}_{t a p}}{\partial {V}_{m z Q}} , \frac{\partial {P}_{t a p}}{\partial {V}_{mzOut}} ; \\ {2}^{n d} harmonic \frac{{\partial }^{2} {P}_{t a p}}{{\partial }^{2} {V}_{m z I}} , \frac{{\partial }^{2} {P}_{t a p}}{{\partial }^{2} {V}_{m z Q}} , \frac{{\partial }^{2} {P}_{t a p}}{{\partial }^{2} {V}_{mzOut}} and \\ beat \frac{{\partial }^{2} {P}_{t a p}}{\partial {V}_{m z I} \partial {V}_{m z Q}} , \frac{{\partial }^{2} {P}_{t a p}}{\partial {V}_{m z I} \partial {V}_{m z O u t}} , \frac{{\partial }^{2} {P}_{t a p}}{\partial {V}_{m z Q} \partial {V}_{m z Out}} signals .\end{matrix}$$

These three functions can be used as slope signals. Further, gradient descent or some other optimization algorithm can be used to find local optimum from coarse Max/Min. By referencing to the Ptap and the derivative signals, various bias points of Max/Min/Quad+/Quad− can be accurately found through interpolation. This is shown as MaxFine 506, MinFine 508, Quad+ 510 and Quad− 512 in FIG. 5. Those off grid fine solutions can be found by interpolation and line up substantially perfectly with the overall heat map. The corresponding algorithm for the interpolation is shown in FIG. 6.

In operation, the two MZ modulators, for example, the XI modulator 206 and the XQ modulator 208 in FIG. 2 represent two MZ modulators at a certain location for a given x-y coordinates pair. Those two MZ modulators can transmit minimum power, or they can transmit maximum power at that location. A full sweep of the input bias signal is applied on the Xouter MZ modulator 210. The X phase outer modulator 210 will change the phase relationship between the XI modulator 206 and XQ modulator 208. After that phase information is changed, optical lights out of two XI and XQ modulators could interfere with each other differently, that is, they could interfere constructively or destructively. The strongest interference only occurs when both XI and the XQ transmit maximum optical signal. On the heat maps of FIG. 5(a) and FIG. 5(b), this corresponds to the brightest areas for P_{tapOutVar}. Those areas correspond to values that are the maximum signals from I and Q. For the dark regions on the heat maps for P_{tapOutVar}, if either I or Q is at a minimum, then when the phase of the outer MZ modulator is swept, the I and the Q do not beat with each other, or they do not interfere with each other. At those points, the resultant output maximum signal minus minimum signal is very small. At those points, it does not matter what the outer phase is, they always output the same optical power.

FIG. 5(a) and FIG. 5(b) provide an indication of the inner modulator maximum bias points. For example, in FIG. 5(a), on the X axis at a value of about 0.3, the maximum value of MZI occurs. Further in 5(a), on the Y axis at a value of −0.2, the maximum value of MZQ occurs. These correspond to the MZI and MZQ maximum bias points.

Beyond providing the full bias map from 3D data, the heat maps in FIG. 5(a) and FIG. 5(b) also provide information about optical power capability per polarization at the brightest P_{tapOutVar}. For getting optical power per tributary, the modulator bias selection needs to be used so that only one tributary is biased at maximum and all others are at minimum (virtually turned off) from the previously found bias map.

The heat maps illustrated in FIG. 5(a) and FIG. 5(b) may be termed a biasing map for inner MZs. X tap and Z tap could give biasing map for MZ_I and MZ_Q in x polarization. Y tap and Z tap could give biasing map for MZ_I and MZ_Q in y polarization. The biasing maps indicate values for V_mzI [Vπ] (x axis) and for V_mzQ [Vπ] (y axis) at which the key biasing points such as MaxCoarse 502, MinCoarse 504, etc., may be located. It is to be noted that, in accordance with the system and method disclosed herein, no prior knowledge of the modulator biasing map is needed to determine proper IQ modulator biasing and optical power characteristics. Only the bandwidth and tuning efficiency of the modulator phase shifter is required as the input of the operation. The phase shifter's bandwidth and tuning efficiency are consistent for a given design and fabrication process since no sensitive optical interference is involved, as opposed to the MZ structure. In contrast, the bias set for operation condition is random for a given modulator as indicated in FIG. 5. For example, x and y polarization of the same QPMZ would give very different bias locations, which leads to the bright spot coordinates difference between FIG. 5(a) and FIG. 5(b). Information about the bandwidth and tuning efficiency may be read from, for example, may be stored in non-volatile memory on a circuit card including optical components such as the QPMZ modulator 102. Information about bandwidth may be used to select the frequency of the fastest sweep signal. The frequency of the fastest sweep signal should be kept within the bandwidth of the device. The tuning efficiency may be used to determine the extent of the sweep needed to characterize the bias points. In FIG. 5(a) and FIG. 5(b), the sweep values on both the horizontal and vertical axes cover a range of about −1.5*Vπ to +1.5*Vπ. Tuning efficiency is used to select the values of Vx. The higher the tuning efficiency of the material, the smaller the required Vx. The higher the bandwidth, the faster the sweep could be performed. Thus, the tuning efficiency and the bandwidth may be considered inputs to the illustrated system and method.

An MZ structure such as those illustrated in FIG. 2 may exhibit non-idealities. On example of such a non-ideality is MZ extinction ratio estimation of both inner and outer MZs. This relates to the imbalance between two arms of a given MZ structure. Information about the MZ extinction ratio estimation can be obtained from the power variation of 3D graphs such as FIG. 5. A second non-ideality is MZ crosstalk with the same polarization. Such MZ crosstalk can be deduced from the 3D function (FIG. 5) as well. This is because all 3 inputs are changed simultaneously as opposed to only one of the 3 is sweeping.

A third MZ structure non-ideality is MZ x-tap and y-tap leakage to each other. When only MZ voltages change on X pol (the X polarity side), signals on Y pol (the Y polarity side) should be not affected. Any leakage from X pol to Y pol can be detected. First, one can use the Xtap result with Xpol modulator 3D sweep to see the peak to peak power variation, P_xtap_xMZsweep. Second, one can use Xtap result with Ypol modulator 3D sweep to see the peak to peak power variation, P_xtap_yMZsweep. Then, the ratio of P_xtap_yMZsweep/P_xtap_xMZsweep gives the crosstalk from y tap to x tap. The noted MZ structure non-idealities may all be determined by post-processing the 3D data.

It should also be noted that the system and method require no calculation, active bias tracking or bias jumping before or during the 3D sweeps of the QPMZ modulator. Further, the 3D sweeps do not require a step-by-step sequence or waiting time to allow hardware to respond between each of the sweeps. The appropriate bias signals are applied to the biasing inputs of the QPMZ modulator, the sweep input is provided, and data is generated and collected from the QPMZ modulator. The input signals are then iterated so that the fast signal is swept from rail to rail while the remaining two biasing inputs are fixed. Then the mid signal is swept rail to rail while the slow biasing is fixed. Finally, the slow biasing input is swept to collect 3D data and develop the information to form the biasing maps of FIG. 5.

Still further, the 3D biasing map generated from the QPMZ modulator is saved for future use. For example, a full digital map of the IQ modulator is saved for future use. For example, the saved map may be compared with a current map developed some time in the future, after extended time periods of operation of the QPMZ modulator. This comparison, or multiple comparisons over time, may yield information about aging or failure analysis of the QPMZ modulator.

FIG. 6 depicts an illustrative embodiment of a method 600 in accordance with various aspects described herein. The method 600 may be used for post-processing the 3D sweep result and establish one or more fine bias sets for a QPMZ modulator including an I or in-phase modulator and a Q or quadrature phase modulator as inner MZ modulators and an outer MZ modulator. The post-processing method 600 includes iterating through selected series of one dimensional (1D) sweeps from the stored 3D sweep data, without re-doing the sweep to locate operating point and bias information for the QPMZ modulator even they're not on the original sweeping grid. The method 600 may be initiated, for example, during start-up of equipment including the QPMZ modulator.

During the sweep, all data is collected at the combined optical output of the IQ modulator, at Z tap 224 (FIG. 2), and post-processed. Data collection and post-processing may be done in any suitable processing system. After the 3D sweep records have been recorded on optical taps, the sample data from ADC 226 (FIG. 2) is re-ordered in I/Q/Outer voltage combinations as shown in FIG. 4. In this example, each of the 3 voltages has 29 independent choices and can be indexed independently.

At step 601, an initial guess of a final bias set is taken from the bias map as shown in FIG. 5, and recorded as Vold=[V_I, V_Q, V_OUT]. This initial guess is on the sweeping grid. At step 602, only a starting set of values for the I modulator and the Q modulator are selected. At step 604, the outer modulator could be moved from the starting value by a few steps and interpolated between sweeping steps to find its optimum location even if it is off grid and recorded as V_OUT′.

In step 606, the Q modulator V_Q and the outer modulator V_OUT′ are kept at an on-grid location that is closest to their current location. At step 608, the I modulator could move from its location by a few steps and interpolation could be performed to find off grid points and recorded as V_I′.

At step 610, the I modulator V_I′ the outer modulator V_OUT′ are kept at on grid location that is closest to their current location. At step 612, the Q modulator could move from its location by a few steps and interpolation could be performed to find off grid points and recorded as V_Q′.

At step 614, the newly obtained I/Q/Outer voltage are recorded as Vnew=[V_I, V_Q, V_OUT]. This new value is compared with the old value Vold in step 616 and determines if they're close enough for loop convergence. If the post-processing loop converges, the desired bias voltage set is obtained even if it is off grid. If not, then the Vold is updated with Vnew as in step 620. An reiterate this process again from step 602 will be followed until convergence is achieved. With the help of the original bias map of the inner MZs, convergence can normally be achieved within 4 iterations. With today's processer technology, this analysis is nearly instantaneous and provides very good starting point for over life close loop control.

Post-processing may include any suitable manipulation of the data including determining derivatives, interpolating, quantizing, and other operations. In some examples, the information shown in FIG. 5(a) and FIG. (b) is developed from post-processing. This includes locating and plotting features such as a MaxCoarse 502 value, a MinCoarse 504 value corresponding to the maximum and minimum values of the function Ptap_x, Ptap_y or Ptap_z on the analytical grid. This may further include locating and plotting a MaxFine 506 value and a MinFine 508 value, which correspond to maximum and minimum for the noted function after resolution to find a more exact location. Further, this may include finding quadrature values including Quad+ 510 and Quad− 512. In general, the noted points repeat periodically, with a period of 2Vπ. The noted points closest to 0 on the x axis and y axis are located.

The method 600 of FIG. 6 operates to find an initial bias point for a QPMZ modulator. For the dual polarization IQ modulator structure 200, the method 600 may be repeated for the X modulator 202 and the Y modulator 204 if the Z tap is the main tap used for data analysis. For example, while the X polarity modulator 202 is being swept with the input signal, the Y polarity modulator 204 is maintained at a steady state. Similarly, while the Y polarity modulator 204 is being swept with the input signal, the X polarity modulator 202 is maintained at a steady state. FIG. 5(a) shows graphically a result for an X polarity modulator such as X modulator 202. FIG. 5(b) shows graphically a result for a Y polarity modulator such as Y modulator 204. The X and Y polarity could also be swept together, if the X/Y taps were used for each of the polarization. X tap should be independent of Y polarization voltage sweeps and Y tap should also be independent of X polarization voltage sweeps.

Additional data may be collected to find an initial bias point for the second modulator of the dual polarization IQ modulator structure 200. These results form an open-loop solution. Subsequently, a closed loop control loop may operate to maintain the bias at a stable operating point. The illustrated process provides starting values for the closed loop control. The starting values are highly accurate bias points for the QPMZ modulator 102. In an example, the dual polarization IQ modulator structure 200 is embodied as a circuit card mounted in a rack to provide optical communication capability. The rack may be located in a data center, for example, or at a gateway in optical communication with optical fibers forming a branch of a network. A system administrator may power-up the card and specify a desired operating wavelength or operating condition. An example is “min/min/quad,” which is a predefined bias condition for the QPMZ modulator 102 and in which each internal MZ modulator is biased at a minimum of its respective response function, and a phase bias signal is set to maintain quadrature (i.e. a 90° phase difference) between the two modulated branch signals, I modulator and Q modulator in x or y polarization. This setting may be generating Quadrature Phase Shift Keying (QPSK) and Quadrature Amplitude Modulation (QAM) symbol constellations, for example. After the predefined bias condition is specified, the method 600 of FIG. 6 operates to find and populate the required bias signals. Subsequently, a closed-loop bias control will operate to maintain the proper bias signals throughout the operation of the circuit card.

In another application, at the time of manufacture of the QPMZ modulator 102 or the circuit card including the QPMZ modulator 102, the quadrature points Quad+ and Quad-identified by the method 600 are required for calibration.

While for purposes of simplicity of explanation, the respective processes are shown and described as a series of blocks in FIG. 6, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

The disclosed system and method provide for identification and establishment of an optimum bias point for an IQ modulator. Rather than conventional one-dimensional (1D) voltage sweeps that are repeated for each individual I, Q and outer modulator of a Mach-Zehnder (MZ) structure, the disclosed system and method provide for a single, three-dimensional (3D) sweep to capture all required biasing data in a short amount of time. The details of the biasing points can be refined via post-processing.

The 3D sweep is enabled by using sinewave dither having an amplitude Vpp>2Vπ. The 3D sweep can be finished in a reasonable time, such as a few seconds, by this configuration. Sweeping with a sinewave provides best voltage transparency when phase shifter bandwidth is limited, which is generally the case for integrated modulators.

The process of 3D data capture records the full map of the IQ modulator, with no need to turn off or disable any of the tributaries completely by bias tracking and bias jumping during the sweep process. The sweep process is simplified by iterating the application of the sweep signal among the I modulator, the Q modulator and the outer modulator of the MZ structure. Interactions between I/Q and outer MZ control voltages are captured and stored for analysis.

In another substantial benefit, 3D analysis is possible with only the combined output at the Z tap of the IQ modulator. I/Q taps are not needed in this method to provide mzI and mzQ details. The analysis Z tap provides the best representation of the high-speed data path through the IQ modulator. Compared to I/Q taps, X and Y tap are also more representative of the data path.

Determination of the derivative of the optical IQ modulator transfer function may be performed by post-processing the output data from the 3D sweep process. This enables virtual bias control loops to converge on any desired bias combination. This is not limited by any hardware response or synchronization speed. A full bias map can be derived from the 3D sweep result and used for optical property analysis. All optical properties including optical loss, extinction ratio, phase bias crosstalk of the IQ modulator can be postprocessed with the derived full bias map. Any of the tributary can be turned on or off virtually after the data is taken.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
applying, by a processing system including a processor, a plurality of time-varying bias signals to bias inputs of a quad-parallel Mach-Zehnder (QPMZ) modulator;
receiving, by the processing system, output signals of the QPMZ modulator, wherein the output signals are produced by the QPMZ modulator responsive to the plurality of time-varying bias signals; and
determining, by the processing system, one or more of a biasing map, power capability, or MZ structure non-idealities for the QPMZ modulator based on the output signals of the QPMZ modulator.

2. The method of claim 1, further comprising:
identifying, by the processing system, a plurality of biasing values for operation of the QPMZ modulator; and
initiating, by the processing system, operation of the QPMZ modulator based on the plurality of biasing values for operation.

3. The method of claim 2, further comprising:
initiating, by the processing system, a closed loop control operation to maintain the QPMZ modulator at an operating condition based on the plurality of biasing values for operation.

4. The method of claim 1, wherein the applying the plurality of time-varying bias signals comprises:
applying, by the processing system, the plurality of time-varying bias signals substantially simultaneously.

5. The method of claim 4, comprising:
applying, by the processing system, a fast signal to a first bias input of the QPMZ modulator;
applying, by the processing system, a mid signal to a second bias input of the QPMZ modulator; and
applying, by the processing system, a slow signal to a third bias input of the QPMZ modulator,
wherein the fast signal has a relatively high frequency, the slow signal has a relatively low frequency, and the mid signal has a frequency between the relatively high frequency and the relatively low frequency.

6. The method of claim 5, comprising:
iterating, by the processing system, an application of the fast signal, the mid signal and the slow signal among the first bias input, the second bias input and the third bias input of the QPMZ; and
collecting, by the processing system, the output signals of the QPMZ modulator according to the iterating to determine the biasing map.

7. The method of claim 1, wherein the applying the plurality of time-varying bias signals to the bias inputs comprises:
applying, by the processing system, a slow signal to a first bias input and a mid signal to a second bias input; and
sweeping, by the processing system, a fast signal at a third bias input to cause the QPMZ modulator to generate first output signals.

8. The method of claim 7, wherein the sweeping the fast signal at the third bias input comprises:
sweeping, by the processing system, a sinusoidal signal having a predetermined amplitude and frequency at the third bias input.

9. The method of claim 7, comprising:
applying, by the processing system, the mid signal to the first bias input and the slow signal to third bias input; and
sweeping, by the processing system, the fast signal at the second bias input to cause the QPMZ modulator to generate second output signals.

10. The method of claim 9, comprising:
applying, by the processing system, the mid signal to the third bias input and the slow signal to third bias input;
sweeping, by the processing system, the fast signal at the third bias input to cause the QPMZ modulator to generate third output signals; and
determining, by the processing system, the biasing map for the QPMZ modulator based on any of the first output signals, the second output signals or the third output signals.

11. The method of claim 10, comprising:
converting, by the processing system, the first output signals, the second output signals and the third output signals to output digital data in an analog to digital converter device; and
postprocessing, by the processing system, the output digital data to develop the biasing map for the QPMZ modulator.

12. The method of claim 1, further comprising:
providing, by the processing system, digital input data to a digital to analog converter; and
providing, by the processing system, the plurality of time-varying bias signals from the digital to analog converter to the bias inputs of the QPMZ modulator, wherein the plurality of time-varying bias signals are produced by the digital to analog converter responsive to the digital input data.

13. A non-transitory machine-readable medium, comprising executable instructions that, when executed by a processing system including a processor, facilitate performance of operations, the operations comprising:
providing input digital data to a digital to analog converter;
receiving, from the digital to analog converter, a dither signal, wherein the dither signal includes a fast signal, a mid signal and a slow signal;
applying the fast signal, the mid signal and the slow signal to selected bias inputs of a quad-parallel Mach-Zehnder (QPMZ) modulator;
iterating the fast signal, the mid signal and the slow signal among the selected bias inputs of the QPMZ modulator to identify bias values for operation of the QPMZ modulator;
applying bias signals corresponding to the bias values for operation of the QPMZ modulator; and
initiating operation of the QPMZ modulator.

14. The non-transitory machine-readable medium of claim 13, wherein the operations further comprise:
selecting frequencies for the fast signal, the mid signal and the slow signal according to
$${F}_{fast} , {F}_{mid} <= 2 * {F}_{fast} / N , and {F}_{s l o w} <= 2 * {F}_{mid} / N = {F}_{fast} / {( N / 2 )}^{2}$$
wherein F_{fast} is an operating frequency of the fast signal, F_{mid} is an operating frequency of the mid signal and F_{slow}, and N is a samples per period.

15. The non-transitory machine-readable medium of claim 14, wherein the applying the fast signal, the mid signal and the slow signal to selected bias inputs of the QPMZ modulator comprises:
providing a sine wave as the fast signal to selected bias inputs of the QPMZ modulator.

16. The non-transitory machine-readable medium of claim 13, wherein the operations further comprise:
selecting an amplitude for the fast signal, the mid signal and the slow signal, wherein the amplitude is selected to be greater than at least 2*Vx, where Vx is a characteristic of the QPMZ modulator.

17. The non-transitory machine-readable medium of claim 13, wherein the applying the fast signal, the mid signal and the slow signal to selected bias inputs of the QPMZ modulator comprise:
selectively providing the fast signal, the mid signal and the slow signal to an in-phase (I) modulator, a quadrature phase (Q) modulator, and an outer modulator of the QPMZ modulator; and
receiving output signals of the QPMZ modulator, the output signals generated by the QPMZ modulator responsive to the fast signal, the mid signal and the slow signal, the output signal indicative of operation of the I modulator, the Q modulator and the outer modulator of the QPMZ modulator.

18. The non-transitory machine-readable medium of claim 17, wherein the operations further comprise:
converting the output signals of the QPMZ modulator to digital output data in an analog to digital to converter; and
processing the digital output data to identify the bias values for operation of the QPMZ modulator.

19. The non-transitory machine-readable medium of claim 18, wherein the processing the digital output data comprises:
evaluating a derivative of a transfer function of the QPMZ modulator; and
identifying the bias values for operation of the QPMZ modulator based the derivative of the transfer function of the QPMZ modulator;
evaluating the optical performance of the QPMZ modulator including but not limited to optical power capability, extinction ratio, crosstalk and optical tap characteristics.

20. The non-transitory machine-readable medium of claim 17, wherein the receiving output signals of the QPMZ modulator comprises:
receiving the output signals at a Z tap of the QPMZ modulator, the Z tap forming a combined output of the QPMZ modulator, to identify modulator power capability and distortion degree use obtained bias map in post-processing.
